(19) United States
(12) Patent Application Publication
(10) Pub. No.: US 2026/0370579 A1
(43) Pub. Date: Nov. 19, 2026

(54) REPORTING CHANNEL IMPULSE RESPONSES OF MULTIPLE BEAMS FOR SPATIAL ANALYSIS BY MACHINE LEARNING

(71) Applicant: Google LLC, Mountain View, CA (US)

(72) Inventors: Yushu Zhang, Beijing (CN); Chih-Hsiang Wu, Taipei (TW)

(21) Appl. No.: 19/103,328

(22) PCT Filed: Aug. 12, 2022
(86) PCT No.: PCT/CN2022/112272

§ 371 Date: Feb. 12, 2025

(51) Int. Cl. H04L 43/065; H04L 25/02

(52) U.S. Cl. CPC H04L 43/065; H04L 25/0212

(57) ABSTRACT

This disclosure provides methods and systems for reporting channel impulse responses of multiple beams for spatial analysis by machine learning. For example, a user equipment (UE) transmits to a network entity, an indication of a capability of reporting a channel impulse response (CIR) report. The UE receives a configuration message including parameters for a CIR quantization scheme. The configuration message is transmitted by the network entity based on the indication and used to configure the CIR report. The UE performs, based on the parameters for the CIR quantization scheme, measurements to derive a quantized CIR value. The UE transmits, to the network entity, the CIR report including the quantized CIR value. The CIR report is generated based on the measurements.

### TECHNICAL FIELD

The present disclosure relates generally to channel impulse response (CIR) feedback.

### BACKGROUND

The Third Generation Partnership Project (3GPP) is currently in the process of specifying a new Radio Interface called 5G New Radio (5G NR) as well as a Next Generation Packet Core Network (NG-CN or NGC). The 5G NR architecture will have three components: a 5G Radio Access Network (5G-RAN), a 5G Core Network (5GC), and a User Equipment (UE). In order to facilitate the enablement of different data services and requirements, the 3GPP 5G NR cellular network supports network slicing, which enables the multiplexing of virtualized and independent logical networks on the same physical network infrastructure.

Base stations (or similar network entities) may use machine learning models to predict or manage beams with UEs. The machine learning models may use channel impulse response (CIR) information of multiple beams and compute parameters for configuring beams for use with the UEs. Communicating the CIR information poses many technical problems and challenges.

### SUMMARY

The present disclosure provides methods for reporting channel impulse responses (CIRs) to facilitate artificial intelligence (AI) or machine learning (ML) based analyses or computations at the base stations for beam prediction, including:
Quantization and report for CIR(s)
Additional report associated with a CIR report to facilitate beam quality aware AI/ML based beam prediction

Details of the methods (as well as related systems and techniques) are discussed in detail below.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a block diagram depicting an example for beam prediction by a network entity using machine learning (ML) models, according to some embodiments;

FIG. 2 is a block diagram depicting an example framework for channel state information (CSI), according to some embodiments;

FIG. 3 illustrates an example call flow diagram of providing channel impulse response (CIR) report, according to some embodiments;

FIG. 4 is a flow diagram depicting a method of wireless communications by a user equipment (UE) device, according to some embodiments;

FIG. 5 is a flow diagram depicting a method of wireless communications by a network entity, according to some embodiments;

FIG. 6 illustrates an example call flow diagram of providing CIR report including beam quality information, according to some embodiments;

FIG. 7 is a flow diagram depicting a method of wireless communications by a user equipment (UE) device, according to some embodiments;

FIG. 8 is a flow diagram depicting a method of wireless communications by a network entity, according to some embodiments;

FIG. 9 is a flow diagram depicting a method of reporting CIR by a user equipment (UE) device, according to some embodiments;

FIG. 10 is a flow diagram depicting a method of reporting CIR by a network entity, according to some embodiments.

### DETAILED DESCRIPTION

For ease of illustration, the following techniques are described in an example context in which one or more UE devices and RANs implement one or more radio access technologies (RATs) including at least a Fifth Generation (5G) New Radio (NR) standard (e.g., Third Generation Partnership Project (3GPP) Release 15, 3GPP Release 16, etc.) (hereinafter, “5G NR” or “5G NR standard”). However, the present disclosure is not limited to networks employing a 5G NR RAT configuration, but rather the techniques described herein can be applied to any combination of different RATs employed at the UE devices and the RANs. Also, the present disclosure is not limited to the examples and context described herein, but rather the techniques described herein can be applied to any network environment.

This disclosure provides methods and systems for reporting channel impulse responses of multiple beams for spatial analysis by machine learning. For example, a user equipment (UE) transmits to a network entity, an indication of a capability of reporting a channel impulse response (CIR) report. The UE receives a configuration message including parameters for a CIR quantization scheme. The configuration message is transmitted by the network entity based on the indication and used to configure the CIR report. The UE performs, based on the parameters for the CIR quantization scheme, measurements to derive a quantized CIR value. The UE transmits, to the network entity, the CIR report including the quantized CIR value. The CIR report is generated based on the measurements.

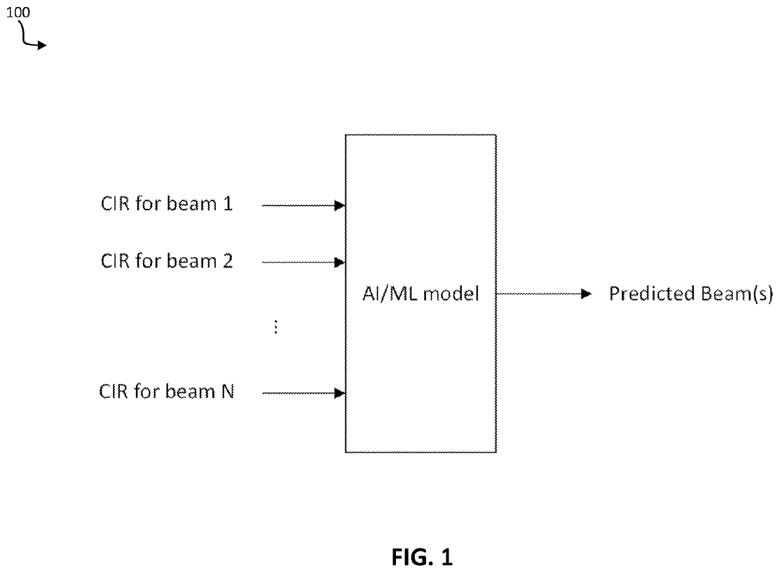

FIG. 1 is a block diagram 100 depicting an example for beam prediction by a network entity using machine learning (ML) models, according to some embodiments. Channel Impulse Response (CIR) is helpful for the network to predict a beam in time and spatial domains, as the CIR carries additional channel properties, e.g., delay spread and angle spread, that are not obtained from the traditional beam report, e.g., layer 1 reference signal receiving power (L1-RSRP) or layer 1 signal-to-interference plus noise ratio (L1-SINR). As shown, the block diagram 100 illustrates an example for an artificial intelligence or a machine learning (AI/ML) based beam selection and/or prediction at the network. CIRs obtained from different beams in at least one component carrier can be used as inputs for an AI/ML model to select or predict one or more beams. The AI/ML model can select or predict at least one beam based on the CIRs. In some examples, the AI/ML model can select or predict one beam for further communication. In some other examples, the AI/ML can select or predict a subset of beams for further beam measurement and report to decreases the number of beams to be measured by the UE, so as to reduce the UE power consumption.

To use the AI/ML based beam management, the network may configure a UE to send SRS for beam management with different beams, so as to derive the CIRs between the UE and cells/TRPs/beams. The maximum transmission power of the UE is much smaller than a gNB. In some cases, the UE may not be able to transmit the SRS in a wide bandwidth due to insufficient transmission power. Then a possible solution is that the UE measures DL signals to obtain CIRs and reports the CIRs to the network instead of transmitting SRS. However, it is unknown how to quantize the CIR to be reported.

In addition, the measurement accuracy for CIRs depends on channel quality. In a bad channel condition, CIRs can introduce additional noise (i.e., interference) to the AI/ML model for beam measurement. Additional inputs for the AI/ML model can be considered to cancel the interference. It is not clear how the UE can report additional information to facilitate the interference cancellation. The present disclosure provides methods for reporting channel impulse responses (CIRs) to facilitate artificial intelligence (AI) or machine learning (ML) based analyses or computations at the base stations for beam prediction, including: quantization and report for CIR(s), and additional report associated with a CIR report to facilitate beam quality aware AI/ML based beam prediction.

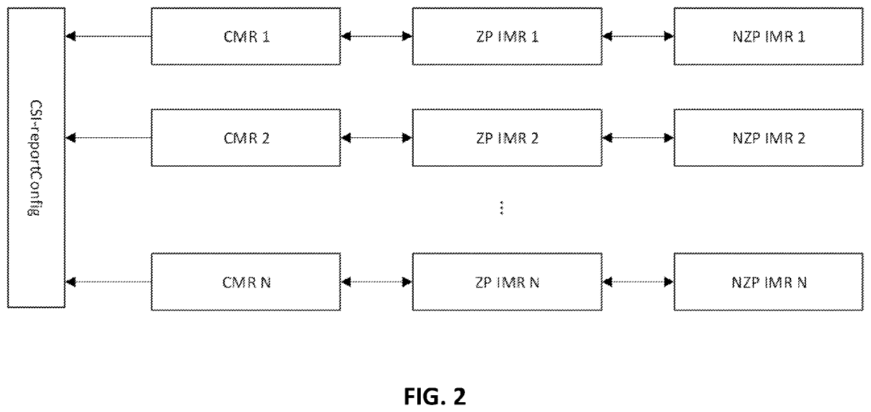

FIG. 2 is a block diagram depicting an example framework for channel state information (CSI), according to some embodiments. For Multiple-Input Multiple-Output (MIMO) system, the channel state information (CSI) is a key information for gNB to select the digital precoder for a UE. Usually, gNB can configure a CSI report by RRC signaling CSI-ReportConfig, where channel state information reference signal (CSI-RS) is used as channel measurement resource (CMR) for UE to measure the downlink channel. Meanwhile, gNB may configure some interference measurement resource (IMR) for UE to measure interference in a CSI-ReportConfig.

One CMR, e.g., one resource configured in resourcesForChannelMeasurement could be associated with one zero power IMR (ZP-IMR), e.g., one resource configured in csi-IM-ResourcesForInterference, and/or non-zero-power IMR (NZP-IMR), e.g., one resource configured in nzp-CSI-RS-ResourcesForInterference. In one example, NZP-IMR can be used for intra-cell interference measurement and ZP-IMR can be used for inter-cell interference measurement. For a UE with multi-beam operation, the UE should use the same beam to receive the CMR as well as the associated IMR(s).

With the help of the associated CMR and IMR(s), UE is able to identify the CSI, which may include rank indicator (RI), precoder matrix indicator (PMI), channel quality indicator (CQI) and layer indicator (LI). RI and PMI are used to determine the digital precoder, CQI is used to reflect the signal-to-interference plus noise (SINR) status so as to assist gNB to determine the modulation and coding scheme (MCS), and LI is used to identify the strongest layer, which can be helpful for MU-MIMO paring with low rank transmission and the precoder selection for phase-tracking reference signal (PT-RS). For a CSI-ReportConfig with more than 1 CMRs configured, UE may report the CSI-RS resource indicator (CRI) associated with the reported RI/PMI/CQI/LI to inform gNB from which CMR the CSI is measured.

The gNB can configure the time domain behavior, e.g., periodic/semi-persistent/aperiodic report, for a CSI report in a CSI-ReportConfig. The gNB can activate or deactivate a semi-persistent CSI report by MAC control element (CE). The gNB can trigger an aperiodic CSI report by Downlink Control Information (DCI). UE may report the periodic CSI by a PUCCH resource configured in CSI-ReportConfig. UE may report the semi-persistent CSI by a PUCCH resource configured in CSI-ReportConfig or PUSCH resource triggered by DCI by gNB. UE may report the aperiodic CSI by a PUSCH resource triggered by DCI by gNB.

While the gNB communicates with the UE, the gNB can configure the UE to perform beam measurement based on the CSI framework, where the gNB can configure the UE to report layer 1 reference signal receiving power (L1-RSRP) or layer 1 signal-to-interference plus noise ratio (L1-SINR) for several CMRs. A CMR can be a synchronization signal block (SSB) or a channel state information reference signal (CSI-RS). The UE performs measurements on the CMR in different time instances and obtains at least one beam quality (e.g., L1-RSRP/L1-SINR) from the measurements. The UE can transmit the at least one beam quality and a beam index (e.g., SSB resource index (SSBRI) or CSI-RS resource index (CRI)). The UE may perform each of the at least one beam report on a PUCCH/PUSCH, where a beam index and beam quality are reported in CSI part 1 in each beam report.

For layer 1 related measurement, the following types of CSI-RSs have been introduced since Rel-15:

CSI-RS for tracking, which is also called as tracking reference signal (TRS). It is a CSI-RS resource set with RRC parameter TRS-Info configured. The TRS is used for time/frequency offset tracking.

CSI-RS for beam management (BM). The CSI-RS for BM is configured in a CSI-RS resource set with RRC parameter repetition configured.

CSI-RS for CSI acquisition. This is a CSI-RS used for CSI measurement and report. The CSI-RS for CSI acquisition is configured in a CSI-RS resource set without RRC parameters TRS-Info and repetition configured.

For AI/ML based beam management, in this disclosure, the corresponding terminology is defined as follows.

| Terminology | Description |
|---|---|
| Data | A process of collecting data by the network nodes, |
| collection | management entity, or UE for the purpose of AI/ML |
| | model training, data analytics and inference |
| AI/ML Model | A data driven algorithm that applies AI/ML techniques |
| | to generate a set of outputs based on a set of |
| | inputs. |
| AI/ML model | A process to train an AI/ML Model [by learning |
| training | the input/output relationship] in a data driven |
| | manner and obtain the trained AI/ML Model for |
| | inference |
| AI/ML model | A process of using a trained AI/ML model to produce |
| Inference | a set of outputs based on a set of inputs |
| AI/ML model | A subprocess of training, to evaluate the quality |
| validation | of an AI/ML model using a dataset different from |
| | one used for model training, that helps selecting |
| | model parameters that generalize |
| | beyond the dataset used for model training. |
| AI/ML model | A subprocess of training, to evaluate the performance |
| testing | of a final AI/ML model using a dataset different |
| | from one used for model training and validation. |
| | Differently from AI/ML model validation, testing |
| | does not assume subsequent tuning of the model. |
| UE-side | An AI/ML Model whose inference is performed entirely |
| (AI/ML) model | at the UE |
| Network-side | An AI/ML Model whose inference is performed entirely |
| (AI/ML) model | at the network |
| One-sided | A UE-side (AI/ML) model or a Network-side (AI/ML) |
| (AI/ML) model | model |
| Two-sided | A paired AI/ML Model(s) over which joint inference |
| (AI/ML) model | is performed, where joint inference comprises AI/ML |
| | Inference whose inference is performed jointly across |
| | the UE and the network, i.e., the first part of |
| | inference is firstly performed by UE and then the |
| | remaining part is performed by gNB, or vice versa. |
| AI/ML model | Delivery of an AI/ML model over the air interface, |
| transfer | either parameters of a model structure known at the |
| | receiving end or a new model with parameters. |
| | Delivery may contain a full model or a partial model. |
| Model | Model transfer from the network to UE |
| download | |
| Model upload | Model transfer from UE to the network |
| Federated | A machine learning technique that trains an AI/ML |
| learning/ | model across multiple decentralized edge nodes (e.g., |
| federated | UEs, gNBs) each performing local model training using |
| training | local data samples. The technique requires multiple |
| | interactions of the model, but no exchange of local |
| | data samples. |
| Offline field | The data collected from field and used for offline |
| data | training of the AI/ML model |
| Online field | The data collected from field and used for online |
| data | training of the AI/ML model |
| Model | A procedure that monitors the inference performance |
| monitoring | of the AI/ML model |
| Supervised | A process of training a model from input and its |
| learning | corresponding labels. |
| Unsupervised | A process of training a model without labelled data. |
| learning | |
| Semi- | A process of training a model with a mix of labelled |
| supervised | data and unlabeled data |
| learning | |
| Reinforcement | A process of training an AI/ML model from input (a.k.a. |
| Learning (RL) | state) and a feedback signal (a.k.a. reward) resulting |
| | from the model's output (a.k.a. action) in an |
| | environment the model is interacting with. |
| Model | enable an AI/ML model for a specific function |
| activation | |
| Model | disable an AI/ML model for a specific function |
| deactivation | |
| Model | Deactivating a currently active AI/ML model and |
| switching | activating a different AI/ML model for a specific |
| | function |

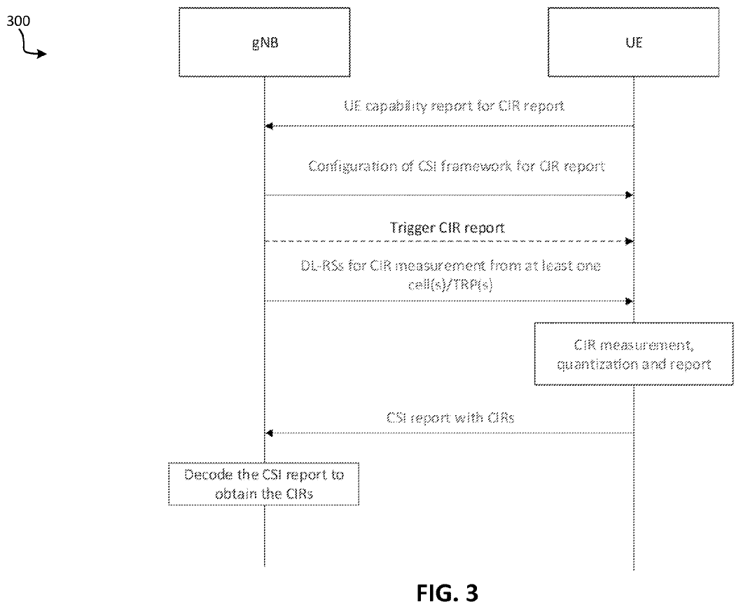

FIG. 3 illustrates an example call flow diagram 300 of providing channel impulse response (CIR) report, according to some embodiments. The following discussion first focuses on the CIR quantization and report. As shown, the call flow diagram 300 illustrates a procedure for CIR quantization and reporting.

Initially, a UE transmits a gNB one or more capabilities for CIR reporting, e.g., maximum number of CSI report configuration for CIR report, maximum number of CMRs for CIR measurement and so on. Alternatively, the gNB receives the one or more capabilities from a core network (e.g., Access and Mobility Management Function (AMF)) or another gNB. Based on the one or more capabilities, the gNB sends the UE at least one RRC message (e.g., RRCReconfiguration message or RRCResume message) to provide configuration parameter(s) for CIR measurement and reporting.

The configuration parameters can configure the CIR reporting as periodic, semi-persistent or aperiodic CIR reporting. In some implementations, the gNB includes the configuration parameters in at least one CSI-ReportConfig IE and includes the at least one CSI-ReportConfig IE in the at least one RRC message.

In one implementation, the configuration parameters include or configure CIR quantization scheme(s) for the CIR quantization. In one implementation, the configuration parameters include a set of DL reference signals (DL-RSs) as CMR(s) and/or IMR(s) for CIR measurement and reporting.

After transmitting the configuration parameters, the gNB can transmit a triggering message (e.g., a MAC CE or DCI) to the UE trigger the UE to transmit CIR(s). In cases where the configuration parameters configure periodic CIR reporting, this triggering message may be skipped. In one implementation, the gNB can transmit a DCI to the UE to trigger an aperiodic CIR reporting. In another implementation, the gNB can transmit a MAC CE to the UE to trigger semi-persistent CIR reporting. The gNB can transmit the DL-RSs via multiple cell(s)/TRP(s). The UE measures the DL-RSs and obtains CIR(s) from the measurement(s). In the case of aperiodic or semi-persistent CIR reporting, the UE can measure the DL-RSs in response to receiving triggering message.

Finally, the UE quantizes the CIR(s), generates a CSI report including the quantized CIR(s), and transmits the CSI report to the gNB on a PUSCH/PUCCH resource. The gNB receives the CSI report on the PUSCH/PUCCH resource and decodes the CSI report to obtain the quantized CIR(s). In some implementations, the PUSCH/PUCCH resource can be configured in the configuration parameters and/or triggering message (e.g., the DCI). Details for each step are provided in the following embodiments.

In an embodiment, the one or more capabilities include at least one of the following capabilities:
Maximum number of CSI report configured for CIR report,
Maximum number of CMRs configured for CIR report per CIR report or across CIR report,
Maximum number of reported CIRs per CIR report,
Maximum number of CMRs configured for CIR report within a slot, and/or
Time domain report behavior (e.g., aperiodic/semi-persistent/periodic) for CIR report.

In an embodiment, the configuration parameters include e.g., CMR/IMR resource, CIR quantization related parameters, and/or report quantity.

In some other implementations, the gNB can configure a list of CSI-RS resource(s) as CMR(s) and/or IMR(s) in the configuration parameters. The gNB can transmit each of the CSI-RS resource(s) from one antenna port. Alternatively, the gNB can transmit each of the CSI-RS resource(s) from more than one antenna ports. In some implementations, the gNB can transmit the CSI-RS resource(s) to the UE via different cells and/or different TRPs of the same cell. Thus, the quasi-co-location sources for the CMRs may be SSBs/CSI-RSs from different cells(s)/TRP(s).

In some implementations, the UE quantizes each of the CIRs based on M frequency domain basis (FD-basis). In one implementation, M is configured in the configuration parameters. In another implementation, M is reported by the UE in the CSI report. In one example, the UE may select the M FD-basis with strongest power or with the power above a threshold. In one implementation, the threshold is configured in the configuration parameters. In another implementation, the threshold is predefined.

In one example, an FD-basis k may be generated based on a Discrete Fourier Transform (DFT) vector as follows:

$${W}_{f}^{k} = {[ \begin{matrix}1 & {e}^{j \frac{2 π k}{{N}_{f} {O}_{f}}} & … & {e}^{j \frac{2 π k ( {N}_{f} - 1 )}{{N}_{f} {O}_{f}}}\end{matrix} ]}^{T}$$

Where N_{f} indicates the length of CIRs, which may be determined by the number of subcarriers per symbol or across all symbols N_{sc} allocated for CMR and/or configured by RRC signaling; O_{f} indicates the oversampling factor, which may be predefined, e.g., O_{f}=1, or determined by N_{f}, or configured by RRC signaling.

In one example, the gNB may configure the number of subcarriers for averaging (N_{sc1}) by RRC signaling, e.g., RRC parameter in CSI-ReportConfig, then N_{f}=ceil(N_{sc}/N_{sc1}).

In another example, an FD-basis k may be generated based on a Discrete Cosine Transform (DCT) vector as follows:

$${W}_{f}^{k} = {[ \begin{matrix}cos ( \frac{π k}{2 {N}_{f} {O}_{f}} ) & cos ( \frac{3 π k}{2 {N}_{f} {O}_{f}} ) & … & cos ( \frac{( 2 {N}_{f} - 1 ) π k}{2 {N}_{f} {O}_{f}} )\end{matrix} ]}^{T}$$

In one implementation, the UE obtains or generates the CIR based on 1 antenna port from the CMR. If the CMR is configured with more than 1 antenna ports in the configuration parameters, the antenna port index for the reported CIR may be predefined, e.g., the first antenna port, or configured in the configuration parameters, or be determined based on the CIR with strongest/weakest power, or reported by the UE in the CSI report. The 1-port CIR can be quantized as follows:

CIR=W_{coef}W_{f}^{H}

Where W_{coef} indicates the coefficients for each FD basis with the dimension of 1 by M, which may or may not be normalized; W_{f} indicates the FD basis matrix with the dimension of N_{f} by M.

$${W}_{coef} = [ \begin{matrix}{d}_{0} & {d}_{1} & … & {d}_{M - 1}\end{matrix} ]$$

$$Or$$

$${W}_{coef} = \frac{1}{\sqrt{{\sum }_{j = 0}^{M - 1} {\vert {d}_{j} \vert}^{2}}} [ \begin{matrix}{d}_{0} & {d}_{1} & … & {d}_{M - 1}\end{matrix} ]$$

$${W}_{f} = [ \begin{matrix}{W}_{f}^{{k}_{0}} & {W}_{f}^{{k}_{1}} & … & {W}_{f}^{{k}_{M - 1}}\end{matrix} ]$$

Then in a CSI report for quantized 1-port CIR, UE needs to report at least the coefficient matrix W_{coef} and the FD basis index(es) k₀, k₁, . . . kₘ₋₁. In one example, the UE may report a bitmap with length of N_{f} to report the FD basis index(es). In another example, the UE may report the M FD basis index(es) explicitly.

In another implementation, the UE obtains or generates the CIR based on all the Np antenna port(s) from the CMR. In one implementation, the UE may report Np sets of coefficient matrix \tilde{W}_{coef} and the FD basis index(es) k₀, k₁, . . . k_{M-1}, where each set correspond to one antenna port. In one example, the UE may report a bitmap with length of N_{f} to report the FD basis index(es). In another example, the UE may report the M FD basis index(es) explicitly. In another implementation, the multi-ports CIR may be quantized as follows:

CIR=Wₛ\tilde{W}_{coef}W_{f}^{H}

Where W_{coef} indicates a beam combining coefficient matrix with the dimension of 2 L by M, which may or may not be normalized; Wₛ indicates a matrix with L spatial domain basis (SD-basis) with the dimension of Np by 2 L, which can be defined as follows:

$${W}_{s} = [ \begin{matrix}B & 0 \\ 0 & B\end{matrix} ]$$

$$B = [ \begin{matrix}{b}_{1} & {b}_{2} & … & {b}_{L}\end{matrix} ]$$

$${b}_{l} = {u}_{m} ⊗ {v}_{n}$$

$${u}_{m} = {[ \begin{matrix}1 & {e}^{\frac{j 2 π m}{{N}_{1} {O}_{1}}} & … & {e}^{\frac{j 2 π ( {N}_{1} - 1 ) m}{{N}_{1} {O}_{1}}}\end{matrix} ]}^{T}$$

$${v}_{n} = {[ \begin{matrix}1 & {e}^{\frac{j 2 π n}{{N}_{2} {O}_{2}}} & … & {e}^{\frac{j 2 π ( {N}_{2} - 1 ) n}{{N}_{2} {O}_{2}}}\end{matrix} ]}^{T}$$

Where, ⊗ denotes Kronecker product; L indicates number of beams which may be configured in the configuration parameters, e.g., RRC parameter in CSI-reportConfig, or predefined, e.g., L=2, or reported by UE, e.g., in the CSI report or UE capability; N₁, N₂, O₁, and O₂ are related to the number of ports and oversampling factor in horizontal and vertical domain, which are configured in the configuration parameters, e.g., RRC parameter n1-n2 in CSI-ReportConfig, and the candidate values should be determined based on number of antenna ports for CMR, e.g., N₁*N₂=Nₚ. Different value of m and n can create different beams. Therefore, in this implementation, the UE may report L sets of SD basis index(es) {m, n}, the matrix coefficient matrix W_{coef} and the FD basis index(es) k₀, k₁, . . . k_{M-1} in a CSI report for multi-port CIR report. In one example, the UE may report a bitmap with length of N_{f} to report the FD basis index(es). In another example, the UE may report the M FD basis index(es) explicitly.

In some implementations, the gNB may configure the UE to report the CIR for a CSI report by indicating a specific value for RRC parameter reportQuantity in a CSI-ReportConfig, e.g., reportQuantity=‘cir’.

In an embodiment, the UE may measure the DL-RSs configured as CMRs for CIR measurement and report. The CIR can be quantized based on the embodiment above.

In the CSI report for CIR reporting, the UE may include at least one of the following fields which is denoted as CIR information:
Index(es) for X CMR(s) with CIR report
Number of beams (L)
Number of FD basis (M)
Length of a FD basis (N_{f})
Quantized CIR(s) corresponding to X CMR(s)

In the “Index(es) for X CMR(s) with CIR report,” the UE may include X CSI-RS resource indicators (CRIs) or X PRS resource indicators (PRI). If the number of reported CIRs is the same as the number of configured CMRs, this field is not reported. If the CIR quantization parameters, e.g., number of beams, number of FD basis and Length of an FD basis, are configured by gNB or predefined, the corresponding field(s) should not be reported. The “quantized CIRs corresponding to X CMR(s)” can be X quantized CIRs, where each quantized CIR is based on the embodiment above, which may include at least one of coefficient matrix, FD basis index(es), and SD basis index(es).

In some implementations, the UE transmits the CSI report in a short PUCCH format, e.g., PUCCH with number of symbols smaller than 4. Then the CIR information may be reported in a single part. In other implementations, the UE transmits the CSI report in a long PUCCH format (e.g., PUCCH with 4 or more than 4 symbols) or on a PUSCH. With these implementations, the CIR information may be included in CSI part 1 of the CSI report. Alternatively, the CIR information may be included in CSI part 2 of the CSI report. Alternatively, a portion of the CIR information may be reported in CSI part 1 of the CSI report and the remaining portion of the CIR information may be reported in CSI part 2 of the CSI reporting.

In one example, the CSI part 1 may include at least one of the following elements:
Index(es) for X CMR(s) with CIR report
Number of beams (L)
Number of FD basis (M)
Length of a FD basis (N_{f})

The remaining portion (if reported) may be included in the CSI part 2.

In another example, the CSI part 1 may include at least one of the following elements:
Index(es) for X CMR(s) with CIR report
Beam index(es)
FD basis index(es)
Length of a FD basis (N_{f})

The coefficient matrix may be included in the CSI part 2.

In some other implementations, the UE transmits a MAC CE including the CIR information to the gNB instead of using a CSI report. More specifically, the UE includes the MAC CE and a subheader of the MAC CE in a MAC PDU and transmits the MAC PDU on a PUSCH. The subheader can include a logical channel identity identifies the MAC CE includes the CIR information.

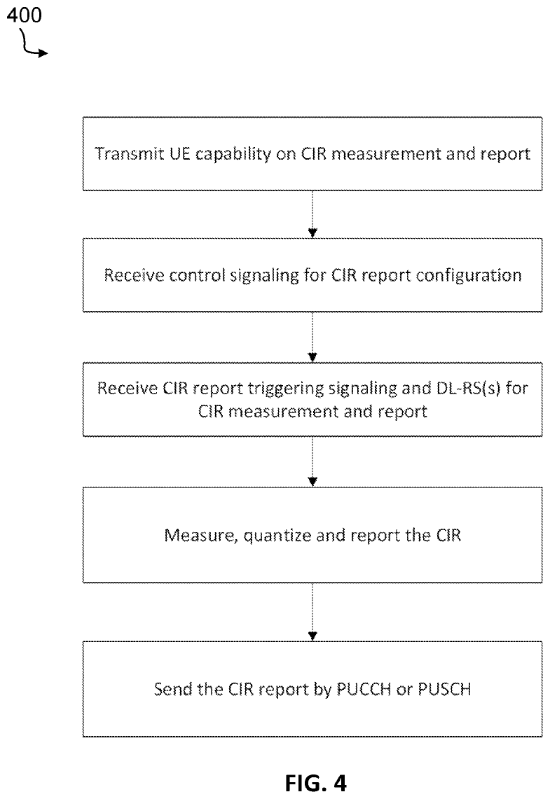

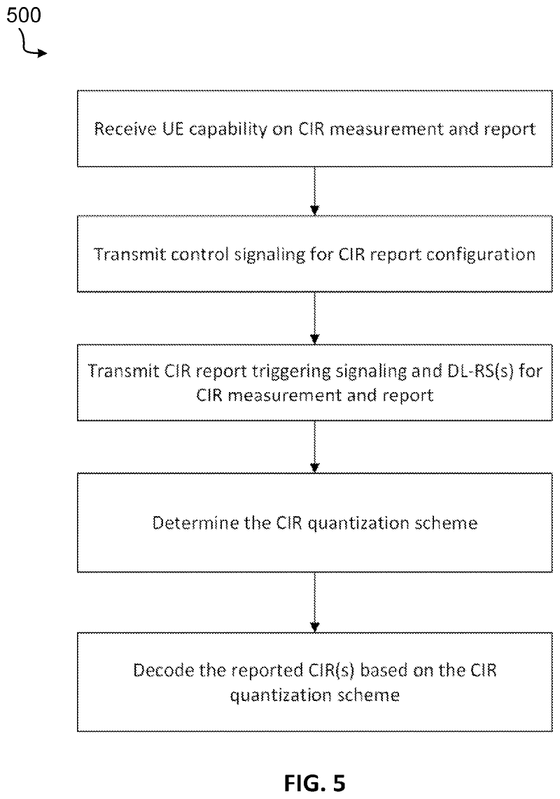

FIG. 4 is a flow diagram depicting a method 400 of wireless communications by a user equipment (UE) device, according to some embodiments. FIG. 5 is a flow diagram depicting a method 500 of wireless communications by a network entity, according to some embodiments. The method 500 may be complementary to the method 400. The methods 400 and 500 may enable the call flow diagram 300 of FIG. 3.

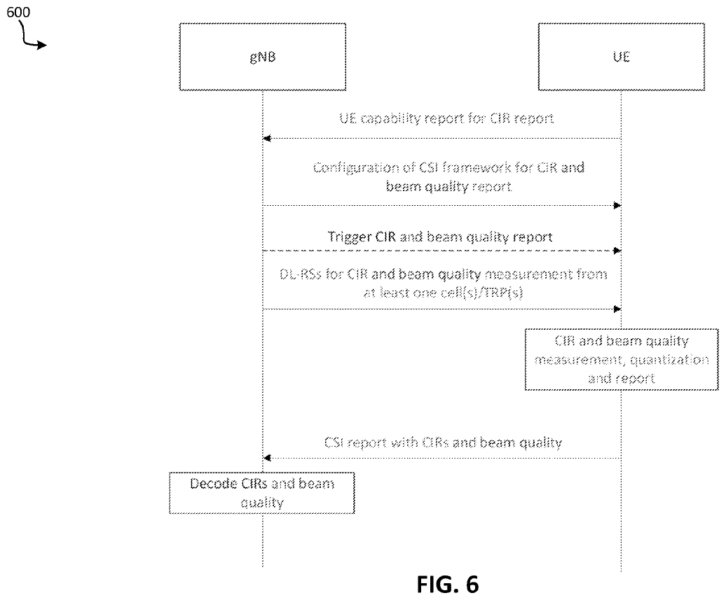

FIG. 6 illustrates an example call flow diagram 600 of providing CIR report including beam quality information, according to some embodiments. The call flow diagram 600 illustrates a general procedure for beam quality aware AI/ML based operation, similar to FIG. 3. The difference between FIG. 6 and FIG. 3 is that the gNB additionally configures the UE to measure and report beam quality, e.g., L1-RSRP/L1-SINR, in the configuration parameters. In some implementations, the gNB configures a set of DL-RSs as CMR(s) and/or IMR(s) and transmits the DL-RSs for beam quality reporting. In some implementations, the gNB configures the set of DL-RSs in the CSI-ReportConfig IE(s) and transmits the at least one RRC message including the CSI-ReportConfig IE(s) to the UE. In some implementations, the set of DL-RSs for CIR reporting and the set of DL-RSs for beam quality reporting include the same different DL-RSs. In other implementations, the DL-RSs for CIR reporting and beam quality reporting include different DL-RSs. In yet other implementations, some of the DL-RSs for CIR reporting and some of the DL RSs for beam quality reporting include the same DL-RS(s) and the rest include different DL-RS(s). The UE may measure the same and/or different DL-RSs and obtain the CIR(s) and beam quality based on the same or different DL-RSs. The UE may quantize the CIR based on the embodiments above for CIR quantization, quantize the measured L1-RSRP/L1-SINR and then report the CIR and L1-RSRP/L1-SINR to the gNB on a PUCCH/PUSCH resource. Details on difference for each step are provided in the following embodiments.

In an embodiment, the gNB may configure the UE to measure the DL-RSs and report CIR and beam quality (e.g., L1-RSRP or L1-SINR) in one of the configuration parameters, e.g., a RRC parameter in the CSI-ReportConfig IE(s). In one example, a new RRC parameter reportQuantity (e.g., reportQuantity-r18) is introduced in a CSI-ReportConfig IE. In one implementation, the new RRC parameter include new candidate value(s) indicating the UE to report CIR and L1-RSRP. For example, the new value(s) include ‘cir-RSRP’, ‘cir-RSRP-18’, ‘cri-CIR-RSRP’, ‘cri-CIR-RSRP-18’, ‘ssb-Index-CIR-RSRP’ and/or ‘ssb-Index-CIR-RSRP-r18’). The word “CIR” and “RSRP” can be swapped. In another implementation, the new RRC parameter include new candidate value(s) indicating the UE to report CIR and L1-SINR. For example, the new value(s) include ‘cir-SINR’, ‘cir-SINR-18’, ‘cri-CIR-SINR’, ‘cri-CIR-SINR-18’, ‘ssb-Index-CIR-SINR’ and/or ‘ssb-Index-CIR-SINR-r18’). The word “CIR” and “SINR” can be swapped. If the UE receives the new RRC parameter reportQuantity (e.g., reportQuantity-r18) in the CSI-ReportConfig IE, the UE can discard or ignore the legacy RRC parameter reportQualitity received in the CSI-ReportConfig IE.

In another example, an additional reportQuantity (e.g., reportQuantity-r18, reportQuantityExt-r18 or reportQuantityAdditonal-r18) is introduced in a CSI-ReportConfig IE and associated with the existing reportQuantity in the CSI-ReportConfig IE. The additional reportQuantity indicates or includes one or more values indicating a reporting type CIR (e.g., ‘cri’, ‘cri-cir’, ‘ssb-Index-CIR’, ‘cri-CIR-r18’, and/or ‘ssb-Index-CIR-r18’). In one implementation, the gNB can configure the UE to report L1-RSRP and CIR by setting the existing reportQuantity=‘cri-RSRP’ or ‘ssb-Index-RSRP’ and additional reportQuantity=‘cri’, ‘cri-cir’, ‘ssb-Index-CIR’, ‘cri-CIR-r18’, or ‘ssb-Index-CIR-r18’. In another implementation, the gNB configures the UE to report L1-SINR or CIR by setting the existing reportQuantity-r16=‘cri-SINR-r16’ or ‘ssb-Index-SINR-r16’ and additional reportQuantity=‘cri’, ‘cri-cir’, ‘ssb-Index-CIR’, ‘cri-CIR-r18’, or ‘ssb-Index-CIR-r18’.

In one implementation, if the UE is configured to report CIR and L1-RSRP, the UE can obtain the CIR and L1-RSRP based on measurements on the same set of CMR(s). In another implementation, if UE is configured to report CIR and L1-RSRP, the UE may obtain the CIR and L1-RSRP based on measurements on the separate sets of CMR(s). Thus, gNB may configure a first set of CMR(s) for CIR measurement and a second set of CMR(s) for L1-RSRP measurement by RRC signaling, e.g., RRC parameter in CSI-ReportConfig.

In one implementation, if UE is configured to report CIR and L1-SINR, UE may measure the CIR and L1-SINR based on the same set of CMR(s). Then gNB may configure a set of IMR(s), where the IMR(s) and CMR(s) are one-to-one associated. Then UE may measure the L1-SINR based on the configured CMR(s) and IMR(s).

In another implementation, if UE is configured to report CIR and L1-SINR, UE may measure the CIR and L1-SINR based on the separate sets of CMR(s). Thus, gNB may configure a first set of CMR(s) for CIR measurement, a second set of CMR(s) and a set of IMR(s) for L1-SINR measurement by RRC signaling, e.g., RRC parameter in CSI-ReportConfig. The IMR(s) and the second set of CMR(s) are one-to-one associated.

In some implementations, the first set of CMR(s) and the second set of CMR(s) may be one-to-one associated. The associated CMRs may be quasi-co-located or share the same quasi-co-location properties, e.g., the associated CMRs may be transmitted based on the same beam.

In some implementations, the gNB may configure the number of reported L1-RSRP/L1-SINR by RRC signaling, RRC parameter in CSI-ReportConfig.

In an embodiment, the UE may report the CIR information and L1-RSRP/L1-SINR information by PUCCH/PUSCH configured or triggered by the gNB, where the L1-RSRP/L1-SINR information may include at least one of the following elements:
Index(es) for X CMR(s) in the CMR(s) for L1-RSRP/L1-SINR report
L1-RSRP/L1-SINR for the corresponding to X CMR(s)

For the “Index(es) for X CMR(s) in the CMR(s) for L1-RSRP/L1-SINR report,” if the L1-RSRP/L1-SINR and CIR share a common set of CMRs, the first set of CMR(s) should be applied; otherwise, the second set of CMR(s) should be applied. This element may not be reported if the number of configured CMRs is the same as number of reported CMRs.

For the “L1-RSRP/L1-SINR for the corresponding to X CMR(s),” the UE may report differential L1-RSRP/L1-SINR starting from the second reported CMR(s), where the measured L1-RSRP/L1-SINR for the first reported CMR should be the reference for differential L1-RSRP/L1-SINR calculation.

In some implementations, the CIR may be reported by short PUCCH format, e.g., PUCCH with number of symbols smaller than 4. Then the CIR information and L1-RSRP/L1-SINR information may be reported in a single part.

In some implementations, the CIR may be reported by long PUCCH format, e.g., PUCCH with 4 or more than 4 symbols, or PUSCH. Then the CIR information and L1-RSRP/L1-SINR information may be reported in CSI part 1. Alternatively, the CIR information and L1-RSRP/L1-SINR information may be reported in CSI part 2. Alternatively, the CIR information may be reported in CSI part 1, and L1-RSRP/L1-SINR information may be reported in CSI part 2. Alternatively, the CIR information may be reported in CSI part 2, and L1-RSRP/L1-SINR information may be reported in CSI part 1.

Alternatively, part of the CIR information may be reported in CSI part 1, the remaining portion of the CIR information may be reported in CSI part 2, and L1-RSRP/L1-SINR information may be reported in CSI part 1 or CSI part 2. Alternatively, part of the L1-SINR/L1-RSRP information may be reported in CSI part 1, the remaining portion of the L1-SINR/L1-RSRP information may be reported in CSI part 2, and CIR information may be reported in CSI part 1 or CSI part 2. Alternatively, part of the CIR information and L1-RSRP/L1-SINR information may be reported in CSI part 1, the remaining portion of the CIR information and L1-RSRP/L1-SINR information may be reported in CSI part 2.

In one example, the CSI part 1 may include at least one of the following elements:
Index(es) for X CMR(s) with CIR report
Number of beams (L)
Number of FD basis (M)
Length of a FD basis (N_{f})
Index(es) for X CMR(s) in the CMR(s) for L1-RSRP/L1-SINR report

The remaining elements (if reported) may be reported by CSI part 2.

In another example, the CSI part 1 may include at least one of the following elements:
Index(es) for X CMR(s) with CIR report
Beam index(es)
FD basis index(es)
Length of a FD basis (N_{f})

The coefficient matrix and L1-RSRP/L1-SINR for the corresponding to X CMR(s) may be reported by CSI part 2.

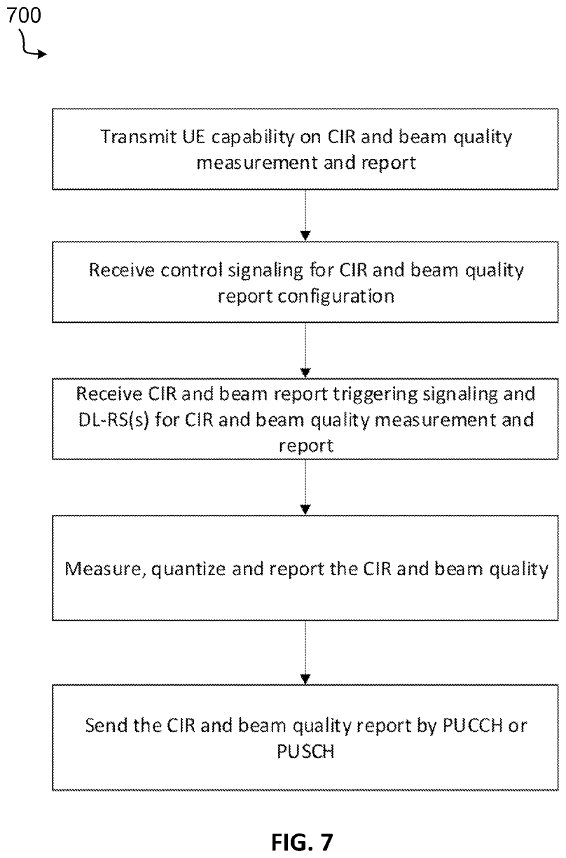

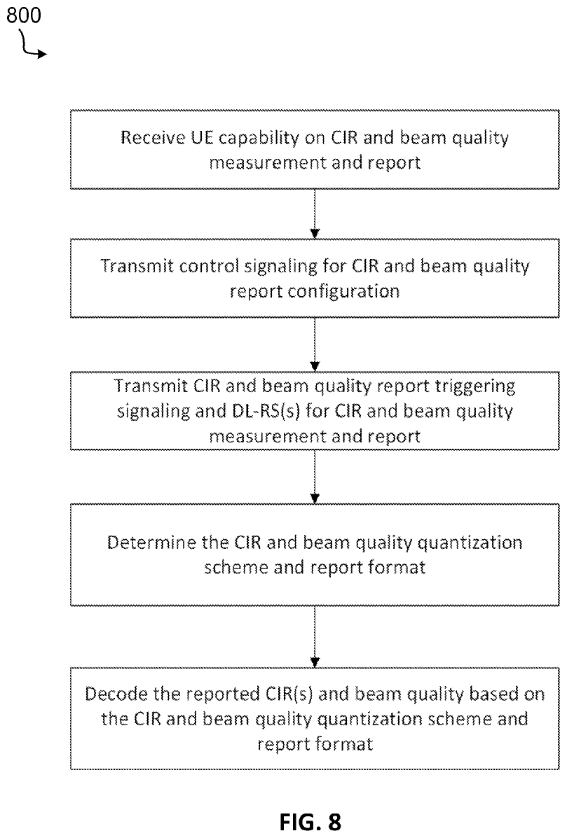

FIG. 7 is a flow diagram depicting a method 700 of wireless communications by a user equipment (UE) device, according to some embodiments. FIG. 8 is a flow diagram depicting a method 800 of wireless communications by a network entity, according to some embodiments. The method 800 may be complementary to the method 700. The methods 700 and 800 may enable the call flow diagram 600 of FIG. 6.

In this disclosure, unless specified, a RRC signaling may indicate a RRC reconfiguration message from gNB to UE, or a system information block (SIB), where the SIB can be an existing SIB (e.g., SIB1) or a new SIB (e.g., SIB J, J>21) transmitted by gNB. In addition, the gNB may obtain the UE capability via UE capability report signaling or from a core network (e.g., Access and Mobility Management Function (AMF)).

Further in this disclosure, solutions described are based on 5G NR technologies. It should be understood that the solutions can be applied to other wireless technologies such as 6G. The “gNB” can be generalized as a base station or a radio access network (RAN) node.

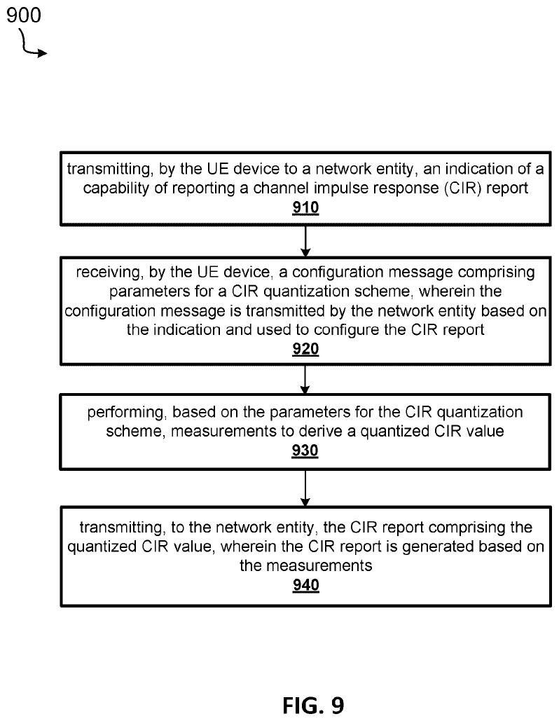

FIG. 9 is a flow diagram 900 depicting a method of reporting CIR by a user equipment (UE) device, according to some embodiments. The method is performed by processing logic that includes hardware (e.g., circuitry, dedicated logic, programmable logic, a processor, a processing device, a central processing unit (CPU), a system-on-chip (SoC), etc.), software (e.g., instructions and/or an application that is running/executing on a processing device), firmware (e.g., microcode), or a combination thereof. The method of the flow diagram 900 is performed by a UE device. The network entity may include one or more radio frequency (RF) modems, a processor coupled to the one or more RF modems, and at least one non-transient memory storing executable instructions to manipulate at least one of the processor or the RF modems to perform the method of the flow diagram 900. A network entity may perform a complimentary method to interact with the UE device performing the method (see call flow diagrams 300 and 600 of FIGS. 3 and 6).

With reference to FIG. 9, method illustrates example functions used by various embodiments. Although specific function blocks (“blocks”) are disclosed in method, such blocks are examples. That is, embodiments are well suited to performing various other blocks or variations of the blocks recited in method. It is appreciated that the blocks in method may be performed in an order different than presented, and that not all of the blocks in method may be performed.

As shown in FIG. 9, the method includes the block 910 of transmitting, by the UE device to a network entity, an indication of a capability of reporting a channel impulse response (CIR) report.

The method includes the block 920 of receiving, by the UE device, a configuration message including parameters for a CIR quantization scheme, wherein the configuration message is transmitted by the network entity based on the indication and used to configure the CIR report.

The method includes the block 930 of performing, based on the parameters for the CIR quantization scheme, measurements to derive a quantized CIR value.

The method includes the block 940 of transmitting, to the network entity, the CIR report including the quantized CIR value, wherein the CIR report is generated based on the measurements.

In some embodiments, the UE device performs the measurements by quantizing, based on the CIR quantization scheme, one or more measurements for obtaining a CIR of a wireless communication channel, and generating one or more quantized values based on the measurements for obtaining the CIR. In some cases, the UE device quantizes the one or more measurements by: determining a spatial domain basis based on multiple beams that the UE device configures according to the configuration message; identifying a matrix coefficient based on the CIR quantization scheme; and determining a frequency domain basis matrix for computing quantized measurements of the CIR with the spatial domain basis and the matrix coefficient.

In some embodiments, the parameters for the CIR quantization scheme includes a set of downlink reference signals. The set of downlink reference signals includes any of: a channel measurement resource (CMR); an interference measurement resource (IMR); a channel state information reference signals (CSI-RSes); and a positioning reference signal (PRS).

In some cases, the UE device may perform the measurements of each reference signal in the set of downlink reference signals. The UE device may provide respective values corresponding to the measurements of each reference signal in the set of downlink reference signals as inputs to a machine-learning model. The UE device may process, by the machine-learning model, the inputs to determine a location of the UE device; wherein the machine-learning model determines one or more spatial properties of the UE device based on signal measurement values in the CIR report.

In some embodiments, the set of downlink reference signals are received at the UE device and are based on the following transmissions: (i) from multiple antenna ports, (ii) from multiple cells, (iii) from multiple transmission/reception points (TRPs), or (iv) corresponding to multiple beams. In some cases, the machine-learning model determines one or more spatial properties of the UE device based on the CIR report of the set of downlink reference signals.

In some embodiments, the configuration message includes a parameter value for a report quantity parameter, the report quantity parameter including any of: a number of beams; a number of frequency domain basis; and a length of frequency domain basis. In some embodiments, the CIR report includes any of: one or more indices for a plurality channel measurement resources (CMRs); the number of beams; the number of frequency domain basis; and the length of frequency domain basis.

In some embodiments, the indication of the capability of reporting the CIR report includes any of: a maximum number of channel state information (CSI) reports configurable as CIR reports; a maximum number of channel measurement resources (CMRs) for each CIR report or across multiple CIR reports; a maximum number of reported CIRs for each CIR report; a maximum number of CMRs configured for CIR report within a slot; and a time domain reporting behavior including one of aperiodic, semi-persistent, and periodic reporting.

The configuration message configures the UE device to generate a beam quality report, in some cases. The method may further include receiving a trigger for generating the beam quality report; performing beam quality measurements based on the trigger; and transmitting, to the network entity, the beam quality measurements with the CIR report.

In some embodiments, the UE device may further configure, based on the configuration message, periodic CIR reporting at UE device; configure, based on the configuration message, aperiodic CIR reporting at UE device; or configure, based on the configuration message, semi-persistent CIR reporting at UE device. The UE device may transmit the CIR report by transmitting the CIR report based on a triggering message that triggers CIR reporting at the UE device. The CIR reporting includes aperiodic CIR reporting or semi-persistent CIR reporting.

In some embodiments, the UE device may detect multiple downlink reference signals that are transmitted from multiple signal sources. For each of the multiple downlink reference signals, the UE device may derive, based on the configuration message, a respective quantized CIR value or respective beam quality information. The UE device may process, by using a machine-learning model, (i) the respective quantized CIR value for one or more of the multiple downlink reference signals and (ii) the respective beam quality information one or more of the multiple downlink reference signals. In response to processing, the UE device may predict, by the machine-learning model, spatial properties that are indicative of a location of the UE device.

In some embodiments, the multiple signal sources include one or more of: a cell, a TRP, or an antenna. Each respective beam quality information includes one or more of: layer 1 reference signal receiving power (L1-RSRP) or layer 1 signal-to-interference plus noise ratio (L1-SINR). A respective quantized CIR value and a respective beam quality information are derived for the same downlink reference signal. In some cases, a plurality quantized CIR values is derived for a first set of CMRs; and multiple beam quality information is derived for a second set of CMRs. The first set of CMRs and the second set of CMRs are the same.

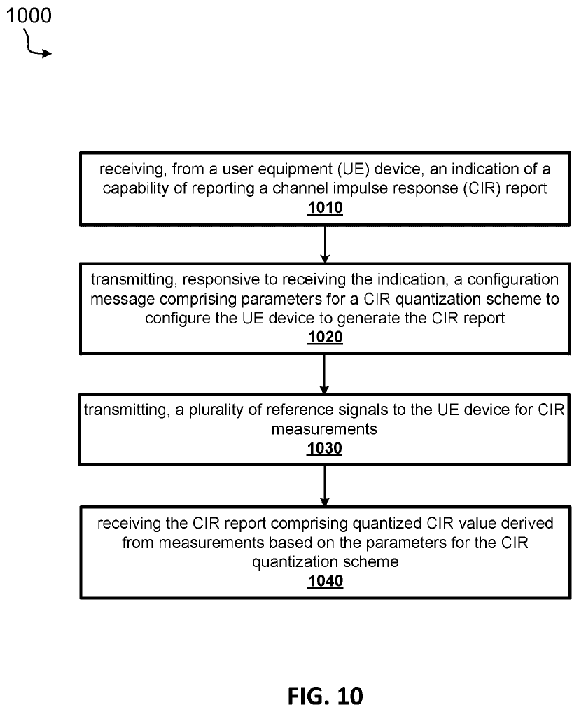

FIG. 10 is a flow diagram depicting a method 1000 of reporting CIR by a network entity, according to some embodiments. The method is performed by processing logic that includes hardware (e.g., circuitry, dedicated logic, programmable logic, a processor, a processing device, a central processing unit (CPU), a system-on-chip (SoC), etc.), software (e.g., instructions and/or an application that is running/executing on a processing device), firmware (e.g., microcode), or a combination thereof. The method of the flow diagram 1000 is performed by a UE device. The network entity may include one or more radio frequency (RF) modems, a processor coupled to the one or more RF modems, and at least one non-transient memory storing executable instructions to manipulate at least one of the processor or the RF modems to perform the method of the flow diagram 1000. A network entity may perform a complimentary method of the flow diagram 1000 to interact with the UE device performing the method (see call flow diagrams 300 and 600 in FIGS. 3 and 6).

With reference to FIG. 10, method illustrates example functions used by various embodiments. Although specific function blocks (“blocks”) are disclosed in method, such blocks are examples. That is, embodiments are well suited to performing various other blocks or variations of the blocks recited in method. It is appreciated that the blocks in method may be performed in an order different than presented, and that not all of the blocks in method may be performed.

As shown in FIG. 10, the method includes the block 1010 of receiving, from a UE device, an indication of a capability of reporting a CIR report. In some embodiments, the configuration message includes a radio resource control (RRC) message configuring a number of subcarrier for averaging.

The method includes the block 1020 of transmitting, responsive to receiving the indication, a configuration message comprising parameters for a CIR quantization scheme to configure the UE device to generate the CIR report.

The method includes the block 1030 of transmitting, a plurality of reference signals to the UE device for CIR measurements.

The method includes the block 1040 of receiving the CIR report comprising quantized CIR value derived from measurements based on the parameters for the CIR quantization scheme.

Unless specifically stated otherwise, terms such as “establishing,” “receiving,” “transmitting,” or the like, refer to actions and processes performed or implemented by computing devices that manipulates data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may include a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a,” “an” and “the” are intended to include the plural forms as well, unless the context clearly indicates otherwise. It will be further understood that the terms “includes,” “including,” “includes,” and/or “including,” when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. § 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the present disclosure to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the present disclosure is not to be limited to the details given herein, but may be modified within the scope and equivalents of the appended claims.

### EXAMPLES

### UE Examples:

1. An apparatus, comprising a processer configured to cause a User Equipment (UE) to:
   a. transmit the UE capability on channel impulse response (CIR) report;
   b. decode control signaling for CSI report configuration for CIR report with at least one downlink reference signal(s) (DL-RSs) configured as channel measurement resource(s) (CMRs) and report quantity configured with at least one CIR report;
   c. measure the CIR based on the configured DL-RS(s);
   d. quantize the measured CIR based on a CIR quantization scheme;
   e. transmit the CIR report with the quantized CIR.
2. The apparatus according to example 1, wherein the UE may report its capability on CIR measurement and report, including at least one of the elements: maximum number of CSI report configured for CIR report, maximum number of CMRs configured for CIR report per CIR report or across CIR report, maximum number of reported CIRs per CIR report, maximum number of CMRs configured for CIR report within a slot, and/or time domain report behavior for CIR report.
3. The apparatus according to example 1, wherein DL-RS(s) configured as CMR(s) may be channel state information reference signal (CSI-RS).
4. The apparatus according to example 1, wherein a CIR may be reported based on multiple antenna ports from a CMR.
5. The apparatus according to example 1, wherein a CIR may be reported based on one antenna port from a CMR.
6. The apparatus according to example 5, wherein the antenna port may be predefined or configured by RRC signaling.
7. The apparatus according to example 5, wherein the antenna port may be determined based on the energy of measured CIRs from each antenna port.
8. The apparatus according to example 5, wherein the 1-port CIR may be quantized as CIR=W_{coef}W_{f}^{H}, where W_{coef} indicates the coefficients for each frequency domain (FD) basis with the dimension of 1 by M, W_{f} indicates the FD basis matrix with the dimension of N_{f} by M, N_{f} is the length of a FD basis, and M is the number of FD basis.
9. The apparatus according to example 8, wherein W_{coef} may be normalized.
10. The apparatus according to example 8, wherein one FD basis may be generated based on a Discrete Fourier Transform (DFT) vector.
11. The apparatus according to example 8, wherein one FD basis may be generated based on a Discrete Cosine Transform (DCT) vector.
12. The apparatus according to example 8, wherein N_{f} may be predefined or configured by RRC signaling.
13. The apparatus according to example 8, wherein N_{f} may be determined by the number of subcarriers for the measured CMR.
14. The apparatus according to example 8, wherein M may be predefined or configured by RRC signaling.
15. The apparatus according to example 8, wherein M may be reported by UE.
16. The apparatus according to example 8, wherein for a quantized CIR, UE may report coefficient(s) in W_{coef} and the index(es) of M FD-basis.
17. The apparatus according to example 5, wherein the multi-port CIR may be quantized as CIR=Wₛ\tilde{W}_{coef}W_{f}^{H}, where \tilde{W}_{coef} indicates a beam combining coefficient matrix with the dimension of 2 L by M; Wₛ indicates a matrix with L spatial domain basis (SD-basis) with the dimension of Np by 2 L, W_{f} indicates the FD basis matrix with the dimension of N_{f} by M, N_{f} is the length of a FD basis, and M is the number of FD basis.
18. The apparatus according to example 17, wherein \tilde{W}_{coef} may be normalized.
19. The apparatus according to example 17, wherein one FD basis may be generated based on a Discrete Fourier Transform (DFT) vector.
20. The apparatus according to example 17, wherein one FD basis may be generated based on a Discrete Cosine Transform (DCT) vector.
21. The apparatus according to example 17, wherein N_{f} may be predefined or configured by RRC signaling.
22. The apparatus according to example 17, wherein N_{f} may be determined by the number of subcarriers for the measured CMR.
23. The apparatus according to example 17, wherein M may be predefined or configured by RRC signaling.
24. The apparatus according to example 17, wherein M may be reported by UE.
25. The apparatus according to example 17, wherein one SD basis may be generated based on a Discrete Fourier Transform (DFT) vector.
26. The apparatus according to example 17, wherein for a quantized CIR, UE may report coefficient(s) in W_{coef}, the index(es) of L SD-basis and the index(es) of M FD-basis.
27. The apparatus according to example 5 or 8, wherein for a quantized CIR, UE may report multiple sets of coefficient(s) in W_{coef} and the index(es) of M FD-basis, where each set corresponds to CIR from each antenna port of the CMR.
28. The apparatus according to example 1, wherein UE may send the quantized CIR in a short PUCCH format in a single CSI part.
29. The apparatus according to example 1, wherein UE may send the quantized CIR in a short PUCCH format in multiple CSI parts.
30. The apparatus according to example 1, wherein UE may send the quantized CIR in a long PUCCH format or PUSCH.
31. The apparatus according to example 30, wherein the quantized CIR(s) may be reported in CSI part 1.
32. The apparatus according to example 31, wherein the quantized CIR(s) may be reported in CSI part 2.
33. The apparatus according to example 31, wherein part of the quantized CIR(s) may be reported in CSI part 1 and the remaining part of the quantized CIR(s) may be reported in CSI part 2.
34. The apparatus according to example 31, wherein the size of quantized CIR(s) reported in CSI part 2 may be determined based on the quantized CIR(s) in CSI part 1.
35. The apparatus according to example 31, wherein quantized CIR(s) reported in CSI part 1 may include at least one of the elements: Index(es) for X CMR(s) with CIR report, number of beams, number of FD basis (M), and Length of a FD basis, and quantized CIR(s) reported in CSI part 2 may include at least one of the elements: coefficient(s) in W_{coef}, the index(es) of L SD-basis and the index(es) of M FD-basis.
36. The apparatus according to example 31, wherein quantized CIR(s) reported in CSI part 1 may include at least one of the elements: Index(es) for X CMR(s) with CIR report, beam index(es), FD basis index(es), and Length of a FD basis, and quantized CIR(s) reported in CSI part 2 may include coefficient(s) in W_{coef}.
37. The apparatus according to example 1, wherein the UE may further:
   a. decode control signaling for CSI report configuration for CIR report and beam quality report with at least one downlink reference signal(s) (DL-RSs) configured as channel measurement resource(s) (CMRs) and report quantity configured with at least one CIR report;
   b. measure the CIR and beam quality based on the configured DL-RS(s);
   c. quantize the measured CIR based on a CIR quantization scheme;
   d. transmit the beam quality report associated with the CIR report with the quantized CIR.
38. The apparatus according to example 37, wherein a common set of CMR(s) may be configured for CIR and beam quality measurement and report.
39. The apparatus according to example 37, wherein a first set of CMR(s) may be configured for CIR measurement and report, and a second set of CMR(s) may be configured for beam quality measurement and report.
40. The apparatus according to example 39, wherein the CMR(s) in the first set may be one-to-one associated with the CMR(s) in the second set.
41. The apparatus according to example 40, wherein the associated CMRs may be quasi-co-located or share the same quasi-co-location properties.
42. The apparatus according to example 31, wherein beam quality may be based on layer 1 reference signal receiving power (L1-RSRP).
43. The apparatus according to example 31, wherein beam quality may be based on layer 1 signal-to-interference plus noise ratio (L1-SINR).
44. The apparatus according to example 41, wherein a set of IMR(s) may be configured by RRC signaling.
45. The apparatus according to example 37, wherein UE may send the quantized CIR and L1-RSRP/L1-SINR in a short PUCCH format in a single CSI part.
46. The apparatus according to example 37, wherein UE may send the quantized CIR and L1-RSRP/L1-SINR in a long PUCCH format or PUSCH.
47. The apparatus according to example 46, wherein the quantized CIR(s) and L1-RSRP/L1-SINR may be reported in CSI part 1.
48. The apparatus according to example 46, wherein the quantized CIR(s) and L1-RSRP/L1-SINR may be reported in CSI part 2.
49. The apparatus according to example 46, wherein the quantized CIR(s) may be reported in CSI part 1 and L1-RSRP/L1-SINR may be reported in CSI part 2.
50. The apparatus according to example 46, wherein the quantized CIR(s) may be reported in CSI part 2 and L1-RSRP/L1-SINR may be reported in CSI part 1.
51. The apparatus according to example 31, wherein part of the quantized CIR(s) and L1-RSRP/L1-SINR may be reported in CSI part 1, and the remaining part of the quantized CIR(s) may be reported in CSI part 2.
52. The apparatus according to example 31, wherein part of the quantized CIR(s) may be reported in CSI part 1, and the remaining part of the quantized CIR(s) and L1-RSRP/L1-SINR may be reported in CSI part 2.
53. The apparatus according to example 31, wherein part of the quantized CIR(s) and part of L1-RSRP/L1-SINR may be reported in CSI part 1, and the remaining part of the quantized CIR(s) and remaining part of L1-RSRP/L1-SINR may be reported in CSI part 2.
54. The apparatus according to example 51-53, wherein CSI part 1 may include at least one of the elements: Index(es) for X CMR(s) with CIR report, number of beams, number of FD basis (M), length of a FD basis and index(es) for X CMR(s) with L1-RSRP/L1-SINR report, and CSI part 2 may include at least one of the elements: coefficient(s) in W_{coef}, the index(es) of L SD-basis, the index(es) of M FD-basis, and L1-RSRP/L1-SINR for the X CMR(s).
55. The apparatus according to example 31, wherein quantized CIR(s) reported in CSI part 1 may include at least one of the elements: Index(es) for X CMR(s) with CIR report, beam index(es), FD basis index(es), length of a FD basis, and index(es) for X CMR(s) with L1-RSRP/L1-SINR report and CSI part 2 may include coefficient(s) in W_{coef} and L1-RSRP/L1-SINR for the X CMR(s).
56. The apparatus according to example 51-53, wherein CSI part 1 may include at least one of the elements: Index(es) for X CMR(s) with CIR report, number of beams, number of FD basis (M), length of a FD basis and index(es) for X CMR(s) with L1-RSRP/L1-SINR report and corresponding L1-RSRP/L1-SINR, and CSI part 2 may include at least one of the elements: coefficient(s) in W_{coef}, the index(es) of L SD-basis, the index(es) of M FD-basis.
57. The apparatus according to example 31, wherein quantized CIR(s) reported in CSI part 1 may include at least one of the elements: Index(es) for X CMR(s) with CIR report, beam index(es), FD basis index(es), length of a FD basis, and index(es) for X CMR(s) with L1-RSRP/L1-SINR report and corresponding L1-RSRP/L1-SINR, and CSI part 2 may include coefficient(s) in W_{coef}.

### BS Examples

1. An apparatus, comprising a processer configured to cause a Base Station (BS) to:
   a. receive the UE capability on channel impulse response (CIR) report;
   b. transmit control signaling for CSI report configuration for CIR report with at least one downlink reference signal(s) (DL-RSs) configured as channel measurement resource(s) (CMRs) and report quantity configured with at least one CIR report;
   c. transmit DL-RS(s) configured as CMRs;
   d. determine the CIR quantization scheme;
   e. decode the CIR report based on the determined CIR quantization scheme.
2. The apparatus according to example 1, wherein the BS may decode the UE capability on CIR measurement and report, including at least one of the elements: Maximum number of CSI report configured for CIR report, maximum number of CMRs configured for CIR report per CIR report or across CIR report, maximum number of reported CIRs per CIR report, maximum number of CMRs configured for CIR report within a slot, and/or time domain report behavior for CIR report.
3. The apparatus according to example 1, wherein DL-RS(s) configured as CMR(s) may be channel state information reference signal (CSI-RS).
4. The apparatus according to example 1, wherein a CIR may be quantized based on one antenna port from a CMR.
5. The apparatus according to example 5, wherein the antenna port may be predefined or configured by RRC signaling.
6. The apparatus according to example 5, wherein the antenna port may be determined based on the energy of measured CIRs from each antenna port.
7. The apparatus according to example 5, wherein the 1-port CIR may be quantized as CIR=W_{coef}W_{f}^{H}, where W_{coef} indicates the coefficients for each frequency domain (FD) basis with the dimension of 1 by M, W_{f} indicates the FD basis matrix with the dimension of N_{f} by M, N_{f} is the length of a FD basis, and M is the number of FD basis.
8. The apparatus according to example 8, wherein W_{coef} may be normalized.
9. The apparatus according to example 8, wherein one FD basis may be generated based on a Discrete Fourier Transform (DFT) vector.
10. The apparatus according to example 8, wherein one FD basis may be generated based on a Discrete Cosine Transform (DCT) vector.
11. The apparatus according to example 8, wherein N_{f} may be predefined or configured by RRC signaling.
12. The apparatus according to example 8, wherein N_{f} may be determined by the number of subcarriers for the measured CMR.
13. The apparatus according to example 8, wherein M may be predefined or configured by RRC signaling.
14. The apparatus according to example 8, wherein the BS may decode M based on a UE report.
15. The apparatus according to example 8, wherein the BS may decode coefficient(s) in W_{coef} and the index(es) of M FD-basis in a CIR report.
16. The apparatus according to example 1, wherein a CIR may be quantized based on multiple antenna ports from a CMR.
17. The apparatus according to example 5, wherein the multi-port CIR may be quantized as CIR=Wₛ\tilde{W}_{coef}W_{f}^{H}, where \tilde{W}_{coef} indicates a beam combining coefficient matrix with the dimension of 2 L by M; Wₛ indicates a matrix with L spatial domain basis (SD-basis) with the dimension of Np by 2 L, W_{f} indicates the FD basis matrix with the dimension of N_{f} by M, N_{f} is the length of a FD basis, and M is the number of FD basis.
18. The apparatus according to example 17, wherein \tilde{W}_{coef} may be normalized.
19. The apparatus according to example 17, wherein one FD basis may be generated based on a Discrete Fourier Transform (DFT) vector.
20. The apparatus according to example 17, wherein one FD basis may be generated based on a Discrete Cosine Transform (DCT) vector.
21. The apparatus according to example 17, wherein N_{f} may be predefined or configured by RRC signaling.
22. The apparatus according to example 17, wherein N_{f} may be determined by the number of subcarriers for the measured CMR.
23. The apparatus according to example 17, wherein M may be predefined or configured by RRC signaling.
24. The apparatus according to example 17, wherein the BS may decode M based on a UE report.
25. The apparatus according to example 17, wherein one SD basis may be generated based on a Discrete Fourier Transform (DFT) vector.
26. The apparatus according to example 17, wherein for a quantized CIR, the gNB may decode coefficient(s) in W_{coef}, the index(es) of L SD-basis and the index(es) of M FD-basis in a CIR report.
27. The apparatus according to example 5 and 8, wherein for a quantized CIR, the gNB may decode multiple sets of coefficient(s) in W_{coef} and the index(es) of M FD-basis in a CIR report, where each set corresponds to CIR from each antenna port of the CMR.
28. The apparatus according to example 1, wherein BS may decode the quantized CIR in a short PUCCH format in a single CSI part.
29. The apparatus according to example 1, wherein BS may decode the quantized CIR in a long PUCCH format or PUSCH.
30. The apparatus according to example 30, wherein the quantized CIR(s) may be in CSI part 1.
31. The apparatus according to example 31, wherein the quantized CIR(s) may be in CSI part 2.
32. The apparatus according to example 31, wherein part of the quantized CIR(s) may be in CSI part 1 and the remaining part of the quantized CIR(s) may be in CSI part 2.
33. The apparatus according to example 31, wherein the size of quantized CIR(s) in CSI part 2 may be determined based on the quantized CIR(s) in CSI part 1.
34. The apparatus according to example 31, wherein quantized CIR(s) in CSI part 1 may include at least one of the elements: Index(es) for X CMR(s) with CIR report, number of beams, number of FD basis (M), and length of a FD basis, and quantized CIR(s) in CSI part 2 may include at least one of the elements: coefficient(s) in W_{coef}, the index(es) of L SD-basis and the index(es) of M FD-basis.
35. The apparatus according to example 31, wherein quantized CIR(s) in CSI part 1 may include at least one of the elements: Index(es) for X CMR(s) with CIR report, beam index(es), FD basis index(es), and Length of a FD basis, and quantized CIR(s) in CSI part 2 may include coefficient(s) in W_{coef}.
36. The apparatus according to example 1, wherein the BS may further:
   a. transmit control signaling for CSI report configuration for CIR report and beam quality report with at least one downlink reference signal(s) (DL-RSs) configured as channel measurement resource(s) (CMRs) and report quantity configured with at least one CIR report;
   b. transmit DL-RS(s) configured as CMR for the CIR and beam quality measurement and report;
   c. determine the report format for the CIR and beam quality report with a CIR quantization scheme;
   d. decode the CIR and beam quality report based on the determined report format and CIR quantization scheme.
37. The apparatus according to example 37, wherein a common set of CMR(s) may be configured for CIR and beam quality measurement and report.
38. The apparatus according to example 37, wherein a first set of CMR(s) may be configured for CIR measurement and report, and a second set of CMR(s) may be configured for beam quality measurement and report.
39. The apparatus according to example 39, wherein the CMR(s) in the first set may be one-to-one associated with the CMR(s) in the second set.
40. The apparatus according to example 40, wherein the associated CMRs may be quasi-co-located or share the same quasi-co-location properties.
41. The apparatus according to example 31, wherein beam quality may be based on layer 1 reference signal receiving power (L1-RSRP).
42. The apparatus according to example 31, wherein beam quality may be based on layer 1 signal-to-interference plus noise ratio (L1-SINR).
43. The apparatus according to example 41, wherein a set of IMR(s) may be configured by RRC signaling.
44. The apparatus according to example 37, wherein the BS may decode the quantized CIR and L1-RSRP/L1-SINR in a short PUCCH format in a single CSI part.
45. The apparatus according to example 37, wherein the BS may decode the quantized CIR and L1-RSRP/L1-SINR in a long PUCCH format or PUSCH.
46. The apparatus according to example 46, wherein the quantized CIR(s) and L1-RSRP/L1-SINR may be in CSI part 1.
47. The apparatus according to example 46, wherein the quantized CIR(s) and L1-RSRP/L1-SINR may be in CSI part 2.
48. The apparatus according to example 46, wherein the quantized CIR(s) may be in CSI part 1 and L1-RSRP/L1-SINR may be in CSI part 2.
49. The apparatus according to example 46, wherein the quantized CIR(s) may be in CSI part 2 and L1-RSRP/L1-SINR may be in CSI part 1.
50. The apparatus according to example 31, wherein part of the quantized CIR(s) and L1-RSRP/L1-SINR may be in CSI part 1, and the remaining part of the quantized CIR(s) may be in CSI part 2.
51. The apparatus according to example 31, wherein part of the quantized CIR(s) may be in CSI part 1, and the remaining part of the quantized CIR(s) and L1-RSRP/L1-SINR may be in CSI part 2.
52. The apparatus according to example 31, wherein part of the quantized CIR(s) and part of L1-RSRP/L1-SINR may be in CSI part 1, and the remaining part of the quantized CIR(s) and remaining part of L1-RSRP/L1-SINR may be in CSI part 2.
53. The apparatus according to example 51-53, wherein CSI part 1 may include at least one of the elements: Index(es) for X CMR(s) with CIR report, number of beams, number of FD basis (M), length of a FD basis and index(es) for X CMR(s) with L1-RSRP/L1-SINR report, and CSI part 2 may include at least one of the elements: coefficient(s) in W_{coef}, the index(es) of L SD-basis, the index(es) of M FD-basis, and L1-RSRP/L1-SINR for the X CMR(s).
54. The apparatus according to example 31, wherein quantized CIR(s) reported in CSI part 1 may include at least one of the elements: Index(es) for X CMR(s) with CIR report, beam index(es), FD basis index(es), length of a FD basis, and index(es) for X CMR(s) with L1-RSRP/L1-SINR report and CSI part 2 may include coefficient(s) in W_{coef} and L1-RSRP/L1-SINR for the X CMR(s).
55. The apparatus according to example 51-53, wherein CSI part 1 may include at least one of the elements: Index(es) for X CMR(s) with CIR report, number of beams, number of FD basis (M), length of a FD basis and index(es) for X CMR(s) with L1-RSRP/L1-SINR report and corresponding L1-RSRP/L1-SINR, and CSI part 2 may include at least one of the elements: coefficient(s) in W_{coef}, the index(es) of L SD-basis, the index(es) of M FD-basis.
56. The apparatus according to example 31, wherein quantized CIR(s) reported in CSI part 1 may include at least one of the elements: Index(es) for X CMR(s) with CIR report, beam index(es), FD basis index(es), length of a FD basis, and index(es) for X CMR(s) with L1-RSRP/L1-SINR report and corresponding L1-RSRP/L1-SINR, and CSI part 2 may include coefficient(s) in W_{coef}.

1-34. (canceled)

35. A method of wireless communications by a user equipment (UE), the method comprising:
receiving, from a network entity, a configuration message comprising parameters for a channel impulse response (CIR) quantization scheme used to configure a CIR report;
performing, based on the parameters for the CIR quantization scheme, measurements to derive a quantized CIR value; and
transmitting, to the network entity, the CIR report comprising the quantized CIR value, wherein the CIR report is generated based on the measurements.

36. The method of claim 1, further comprising:
transmitting, to the network entity, an indication of a capability of reporting the CIR report, wherein the CIR quantization scheme is based on the indication and wherein performing the measurements further comprises:
quantizing, based on the CIR quantization scheme, one or more measurements for obtaining a CIR of a wireless communication channel; and
generating one or more quantized values based on the measurements for obtaining the CIR.

37. The method of claim 2, wherein quantizing the one or more measurements comprises:
determining a spatial domain basis based on a plurality of beams that the UE configures according to the configuration message;
identifying a matrix coefficient based on the CIR quantization scheme; and
determining a frequency domain basis matrix for computing quantized measurements of the CIR with the spatial domain basis and the matrix coefficient.

38. The method of claim 1, wherein:
the parameters for the CIR quantization scheme comprise a set of downlink reference signals; and
the set of downlink reference signals comprises at least one of:
a channel measurement resource (CMR);
an interference measurement resource (IMR);
a channel state information reference signals (CSI-RSs); or
a positioning reference signal (PRS).

39. The method of claim 4, further comprising:
performing the measurements of each reference signal in the set of downlink reference signals;
providing respective values corresponding to the measurements of each reference signal in the set of downlink reference signals as inputs to a machine-learning model; and
processing, by the machine-learning model, the inputs to determine a location of the UE, wherein the machine-learning model determines one or more spatial properties of the UE based on signal measurement values in the CIR report, wherein the set of downlink reference signals are received at the UE and are based on at least one of:
transmissions from a plurality of antenna ports,
transmissions from a plurality of cells,
transmissions from a plurality of transmission/reception points (TRPs), or
transmissions corresponding to a plurality of beams,
wherein the machine-learning model determines one or more spatial properties of the UE based on the CIR report.

40. The method of claim 1, wherein the configuration message comprises a parameter value for a report quantity parameter, the report quantity parameter comprising at least one of:
a number of beams;
a number of frequency domain basis; or
a length of frequency domain basis.

41. The method of claim 6, wherein the CIR report comprises at least one of:
one or more indices for a plurality channel measurement resources (CMRs);
the number of beams;
the number of frequency domain basis; or
the length of frequency domain basis.

42. The method of claim 6, further comprising:
selecting the number of frequency domain basis with a strongest power.

43. The method of claim 1, wherein the indication of the capability of reporting the CIR report comprises at least one of:
a maximum number of channel state information (CSI) reports configurable as CIR reports;
a maximum number of channel measurement resources (CMRs) for each CIR report or across multiple CIR reports;
a maximum number of reported CIRs for each CIR report;
a maximum number of CMRs configured for CIR report within a slot; or
a time domain reporting behavior comprising at least one of aperiodic, semi-persistent, or periodic reporting.

44. The method of claim 1, wherein the configuration message configures the UE to generate a beam quality report and the method further comprises;
receiving a trigger for generating the beam quality report;
performing beam quality measurements based on the trigger; and
transmitting, to the network entity, the beam quality measurements with the CIR report.

45. The method of claim 1, further comprising at least one of:
configuring, based on the configuration message, periodic CIR reporting at UE;
configuring, based on the configuration message, aperiodic CIR reporting at UE; or
configuring, based on the configuration message, semi-persistent CIR reporting at UE, wherein transmitting the CIR report comprises:
transmitting the CIR report based on a triggering message that triggers CIR reporting at the UE, wherein the CIR reporting comprises aperiodic CIR reporting or semi-persistent CIR reporting.

46. The method of claim 1, further comprising:
detecting, by the UE, a plurality of downlink reference signals that are transmitted from a plurality of signal sources;
for each of the plurality of downlink reference signals: deriving, based on the configuration message, a respective quantized CIR value or respective beam quality information;
processing, by a machine-learning model, (i) the respective quantized CIR value for one or more of the plurality of downlink reference signals and (ii) the respective beam quality information one or more of the plurality of downlink reference signals; and
in response to processing, predicting, by the machine-learning model, spatial properties that are indicative of a location of the UE.

47. The method of claim 12, wherein:
the plurality of signal sources comprises one or more of: a cell, a TRP, or an antenna;
wherein each respective beam quality information comprises one or more of: layer 1 reference signal receiving power (L1-RSRP) or layer 1 signal-to-interference plus noise ratio (L1-SINR); and
wherein a respective quantized CIR value and a respective beam quality information are derived for the same downlink reference signal.

48. A method of wireless communications by a network entity, the method comprising:
transmitting, to a user equipment (UE), a configuration message comprising parameters for a channel impulse response (CIR) quantization scheme to configure the UE to generate a CIR report;
transmitting, to the UE, a plurality of reference signals for CIR measurements; and
receiving, from the UE, the CIR report comprising quantized CIR value derived from measurements based on the parameters for the CIR quantization scheme.

49. The method of claim 14, further comprising:
receiving, from the UE, an indication of a capability of reporting the CIR report, wherein the parameters for the CIR quantization scheme comprise a set of downlink reference signals, and wherein the set of downlink reference signals comprises at least one of:
a channel measurement resource (CMR);
an interference measurement resource (IMR);
a channel state information reference signals (CSI-RSs); or
a positioning reference signal (PRS), wherein the set of downlink reference signals are received at the UE and are based on at least one of:
transmissions from a plurality of antenna ports,
transmissions from a plurality of cells,
transmissions from a plurality of transmission/reception points (TRPs), or
transmissions corresponding to a plurality of beams.

50. The method of claim 14, wherein the configuration message comprises a parameter value for a report quantity parameter, the report quantity parameter comprising at least one of:
a number of beams;
a number of frequency domain basis; and
a length of frequency domain basis, or
wherein the CIR report comprises at least one of:
one or more indices for a plurality channel measurement resources (CMRs);
the number of beams;
the number of frequency domain basis; or
the length of frequency domain basis.

51. The method of claim 14, wherein the indication of the capability of reporting the CIR report comprises at least one of:
a maximum number of channel state information (CSI) reports configurable as CIR reports;
a maximum number of channel measurement resources (CMRs) for each CIR report or across multiple CIR reports;
a maximum number of reported CIRs for each CIR report;
a maximum number of CMRs configured for CIR report within a slot; or
a time domain reporting behavior comprising at least one of aperiodic, semi-persistent, or periodic reporting.

52. The method of claim 14, wherein the configuration message configures the UE to generate a beam quality report and the method further comprises;
transmitting a trigger for generating the beam quality report; and
receiving, from the UE, the CIR report including beam quality measurements.

53. The method of claim 14, wherein receiving the CIR report comprises:
transmitting a triggering message to the UE; and
receiving the CIR report comprising aperiodic CIR reporting or semi-persistent CIR reporting.

54. An apparatus for wireless communication at a user equipment (UE) comprising:
a transceiver;
a memory; and
a processor coupled to the memory and the transceiver, the processor configured to:
receive, from a network entity, a configuration message comprising parameters for a channel impulse response (CIR) quantization scheme used to configure a CIR report;
perform, based on the parameters for the CIR quantization scheme, measurements to derive a quantized CIR value; and
transmit, to the network entity, the CIR report comprising the quantized CIR value, wherein the CIR report is generated based on the measurements.
